(19) United States
(12) Patent Application Publication
(10) Pub. No.: US 2003/0012101 A1
(43) Pub. Date: Jan. 16, 2003

(54) Spindle motor speed control apparatus of optical disc reproducing device

(75) Inventor: Hyun Jeong Park, Suwon-si (KR)

Correspondence Address: SUGHRUE, MION, ZINN, MACPEAK & SEAS, PLLC, 2100 Pennsylvania Avenue, N.W., Washington, DC, 20037-3213, US

(73) Assignee: SAMSUNG ELECTRONICS CO., LTD.

(21) Appl. No.: 10/042,134

(22) Filed: Jan. 11, 2002

(30) Foreign Application Priority Data
Jul. 11, 2001 (JP) 2001-41557

(51) Int. Cl. G11B 7/00

(52) U.S. Cl. 369/47.48; 369/53.35

(57) ABSTRACT

An optical disc reproducing device (hereinafter referred to as a CD player) that reproduces a CD (Compact Disc) audio signal, and more particularly, an apparatus is provided, which is designed to accurately control the speed of a spindle motor by reflecting the gap between two points in a buffer where data is recorded and the recorded data is read respectively. The spindle motor speed control apparatus of the CD player which reproduces an audio signal using data reproduced by the disc and buffered on the buffer includes an EFM demodulator, a frequency error measurement unit, a buffer, a lead/lag detector and a motor control signal generator. The apparatus can dynamically control the speed at which data stored on the disc is read more easily and reliably by controlling the spindle motor speed.

### BACKGROUND OF THE INVENTION

1. Field of the Invention

The present invention relates to an optical disc reproducing device that reproduces a CD (Compact Disc) audio signal, and more particularly, to an apparatus designed to accurately control the speed of a spindle motor based on the gap between points in a buffer where data is recorded and the recorded data is read, respectively.

The present application is based on Korean Patent Application No. 2001-41557, filed Jul. 11, 2001, which is incorporated herein by reference.

2. Description of the Related Art

In a related art optical disc reproducing device (e.g., compact disc player) that reproduces a CD (compact disc) audio signal, the speed for reading data recorded on a disc is not the same as the speed for decoding an audio signal from the read data. Therefore, the speed of a spindle motor is controlled so that the speed at which the data recorded on the disc is read is substantially similar to the speed at which the audio signal is decoded.

According to a related art spindle motor speed control method, a frequency of frame sync included in data read from a disc is compared with a theoretical frequency of frame sync, and the speed of a spindle motor is controlled by the difference between the two values.

In the aforementioned related art spindle motor speed control method, there is a problem in that the audio signal decoding speed is not considered for controlling the speed of the spindle motor. As a solution to that related art problem, the related art CD player uses a buffer that stores the data read from a disc. Decoding of an audio signal is performed by managing the buffer.

FIG. 1 illustrates a related art spindle motor speed control apparatus 100, including an EFM (Eight to Fifteen Modulation) demodulator 104, a frequency error measurement unit 106 and a motor control signal generator 108. The EFM demodulator 104 EFM-demodulates data read from a disc 102 to generate EFM data and extract a WFCK (Write Frame Sync Clock). The frequency error measurement unit 106 compares the extracted WFCK with a theoretical WFCK, and outputs the difference between the WFCKs as an error value. The motor control signal generator 108 accelerates or decelerates the rotation speed of the spindle motor (not shown) that rotates the disc 102, based on the error value generated by the frequency error measurement unit 106.

The related art spindle motor speed control apparatus 100 detects the frequency of the WFCK reproduced from the disc 102, and measures the frequency of the WFCK by counting a clock signal with a fixed frequency. For example, but not by way of limitation, a clock signal may be generated by a crystal oscillator. After comparing the measured WFCK frequency with a theoretical WFCK frequency, the apparatus 100 determines whether the speed for reading a data from the disc 102 is low, and generates an accelerating control signal if the measured frequency is higher than that of the theoretical WFCK. Otherwise, the apparatus 100 generates a decelerating control signal. Thus, the related art spindle motor speed control apparatus as shown in FIG. 1 controls the speed of the spindle motor based on only the WFCK reproduced from the disc 102.

The data read from the disc 102 is stored in the buffer (not shown), and goes through an ECC (Error Code Correction) to generate ECC data. After the ECC is completed, the data is D-to-A (Digital-to-Analog)-converted to generate transfer data, and an audio signal is reproduced. Accordingly, the buffer records the EFM data, generates ECC data after the ECC of the recorded EFM data, reads the ECC data sequentially and transmits the data as transfer data to a D-to-A converter (not shown).

The processes of the EFM and the ECC depend on a channel clock signal generated based on the WFCK reproduced by the disc 102, and the process of the transfer depends on the clock signal with the fixed frequency to prevent any sound distortion. As a result, a faster disc reproduction speed corresponds to a faster audio signal, and a slower disc reproduction speed corresponds to a slower audio signal. Thus, audio reproduction requires a clock signal with a regular frequency (i.e., a clock signal generated by a crystal oscillator). To manage variable areas in the buffer (not shown) for each data to record the EFM data, perform the ECC and transmit the transfer data, pointers are used.

However, the related art spindle motor speed control apparatus 100 controls the speed of the spindle motor based on only the speed at which the data is read from the disc (i.e., transfer data), and not by the speed at which the audio signal is reproduced. Therefore, it is a disadvantage of the related art apparatus 100 that the speed of the spindle motor cannot be controlled in a precise manner.

FIG. 2 is a waveform diagram illustrating the operation of the related art apparatus illustrated in FIG. 1. The first waveform shows the clock signal with the fixed frequency CLK necessary to measure the frequency of the WFCK reproduced by the disc 102. The second diagram shows the theoretical WFCK. The third diagram shows the WFCK reproduced by the disc 102, and the fourth diagram shows the error value (i.e., the difference between the measured WFCK and the theoretical WFCK).

The frequency error measurement unit 106 measures the frequency of the WFCK provided by the EFM demodulator 104, using the clock signal with the fixed frequency CLK, and compares the measured WFCK with the theoretical WFCK to generate the error value. The motor control signal generator 108 controls the speed of the spindle motor based on the error value, typically by varying the pulse width of a pulse signal having the fixed frequency. As shown in FIG. 2 and noted above, the existing spindle motor speed control apparatus controls the speed of the spindle motor using only the WFCK reproduced from the disc.

However, the related art spindle motor speed control method has various problems and disadvantages. For example, but not by way of limitation, the points in the buffer where data is recorded and read are not considered. As noted above, the speed of the spindle motor is controlled based on only the difference between the frequency of frame sync included in data read from a disc and the theoretical frequency of frame sync. Therefore, if a physical factor (e.g., motor rotation characteristics) causes cumulative error values, a related art problem occurs when data recorded in the buffer collides with other data read from the buffer collide, and precise control of the spindle cannot be performed.

### SUMMARY OF THE INVENTION

To solve the above-described problems, it is an object of the present invention to provide an enhanced method of controlling the speed of a spindle motor accurately and reliably by reflecting the gap between two points in a buffer, where data is recorded and the recorded data is read.

To achieve the above object according to the present invention, the spindle motor speed control apparatus of the CD player which reproduces an audio signal includes an EFM demodulator, a frequency error measurement unit, a buffer, a lead/lag detector and a motor control signal generator.

The EFM demodulator EFM-demodulates the data read by the disc and outputs EFM data and a WFCK (Write Frame Sync Clock). The frequency error measurement unit compares the frequency of the WFCK extracted by the EFM demodulator with that of a theoretical WFCK and outputs the difference between the frequencies as an error value. The buffer stores the EFM data, corrects errors of the stored EFM data and stores the transfer data to be transmitted to the external system for reproduction of the audio signal after the error correction. The lead/lag detector compares two points in the buffer where the EFM data is recorded and the transfer data is read, and determines whether the transfer pointer leads or lags behind the EFM pointer. The motor control signal generator controls the speed of the spindle motor of the disc based on the error value provided by the frequency error measurement unit and the lead/lag information detected by the lead/lag detector 208.

The spindle motor speed control apparatus according to the present invention detects lead or lag between the EFM pointer and the transfer pointer and the difference between the two points in the buffer. In addition, the apparatus can control the speed at which data stored on the disc is read more easily and reliably by controlling the spindle motor speed.

Additionally, to achieve at least the aforementioned object, a means for controlling spindle motor speed of an optical disc reproducing device having a buffer that buffers data reproduced from a disc and reproduces an audio signal is provided, comprising an EFM demodulation means for EFM (Eight to Fifteen Modulation)-demodulating the data read by the disc and outputting EFM data and a WFCK (Write Frame Sync Clock). The means for controlling spindle motor speed also comprises a frequency error measurement means for comparing a frequency of the WFCK extracted by the EFM demodulation means with a frequency of a theoretical WFCK and outputting the difference between the extracted WFCK and the theoretical WFCK as an error value, and a buffering means for storing the EFM data, performing ECC (Error Code Correction) of the stored EFM data and storing transfer data to be transmitted to an external system for reproduction of an audio signal after the ECC. Additionally, the means for controlling spindle motor speed comprises a lead/lag detection means for comparing points in the buffering means where the EFM data is recorded and the transfer data is read, and identifying transfer pointer leads or lags behind an EFM pointer, and a motor control signal generating means for controlling the rotation speed of the spindle motor that rotates the disc, based on the error value provided by the frequency error measurement means and lead/lag information detected by the lead/lag detection means.

Further, a spindle motor speed control apparatus is provided, comprising an EFM (Eight to Fifteen Modulation) demodulator that demodulates data reproduced from a disc and outputs EFM data and a WFCK (Write Frame Sync Clock), and a frequency error measurement unit that compares a frequency of the WFCK extracted by the EFM demodulator with a frequency of a theoretical WFCK and outputs the difference between the extracted WFCK and the theoretical WFCK as an error value. The apparatus also comprises a buffer that stores the EFM data, performs ECC (Error Code Correction) of the stored EFM data and stores transfer data to be transmitted to an external system for reproduction of an audio signal after the ECC, a lead/lag detector that compares points in the buffer where the EFM data is recorded and the transfer data is read, and identifies transfer pointer leads or lags behind an EFM pointer, and a motor control signal generator that controls the rotation speed of the spindle motor that rotates the disc, based on the error value provided by the frequency error measurement unit and lead/lag information detected by the lead/lag detector, to reproduce an audio signal.

Also, a method of controlling a spindle motor speed is provided, comprising the steps of (a) demodulating data reproduced from a disc to generate EFM (Eight to Fifteen Modulation) demodulated data and extract a WFCK (Write Frame Sync Clock), (b) comparing a frequency of the extracted WFCK with a frequency of a theoretical WFCK to output an error value comprising a difference between the extracted WFCK and the theoretical WFCK, and (c) buffering the EFM data, performing ECC (Error Code Correction) of the stored EFM data, and storing transfer data to be transmitted to an external system for reproduction of an audio signal after the ECC. The method also includes (d) comparing points where the EFM data is recorded and the transfer data is read to identify transfer pointer leads or lags behind an EFM pointer, and (e) controlling the spindle motor rotation speed based on the error value and the lead/lag information, to reproduce an audio signal.

### BRIEF DESCRIPTION OF THE DRAWINGS

The above object and other advantages of the present invention will become more apparent by describing in detail a preferred embodiment thereof with reference to the attached drawings, in which:

FIG. 1 is a block diagram illustrating the configuration of a related art spindle motor speed control apparatus;

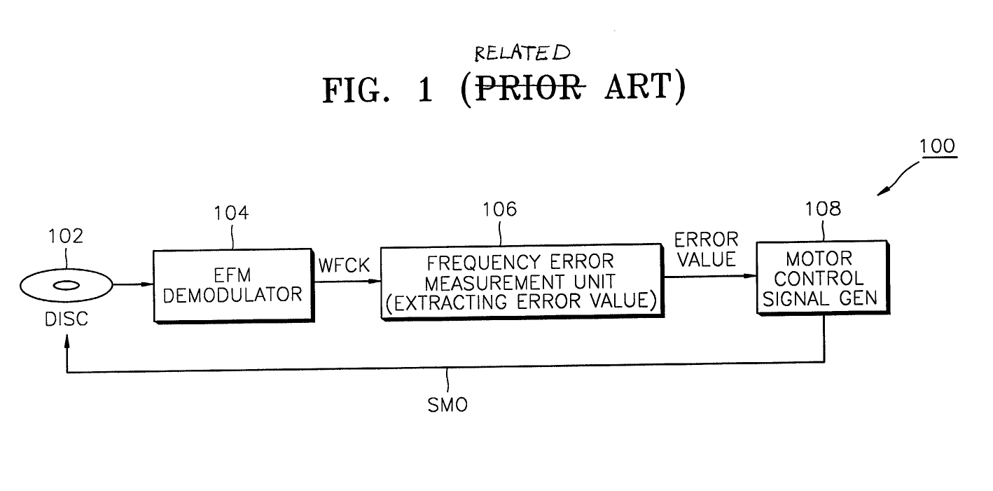

FIG. 2 is a waveform diagram illustrating the operation of the related art apparatus illustrated in FIG. 1;

FIG. 3 is a block diagram illustrating the configuration of a spindle motor speed control apparatus according to the present invention;

FIG. 4 shows the relations among an EFM (Eight to Fifteen Modulation) pointer, an ECC (Error Code Correction) pointer and a transfer pointer in the buffer 208 illustrated in FIG. 3;

FIG. 5 is a waveform diagram illustrating the operation of a lead/lag detector 210 included in the apparatus illustrated in FIG. 3; and

FIG. 6 is a waveform diagram illustrating the operation of a motor control signal generator 212 included in the apparatus illustrated in FIG. 3.

### DETAILED DESCRIPTION OF THE INVENTION

The configuration and operation of the invention will be described in detail with reference to the attached drawings.

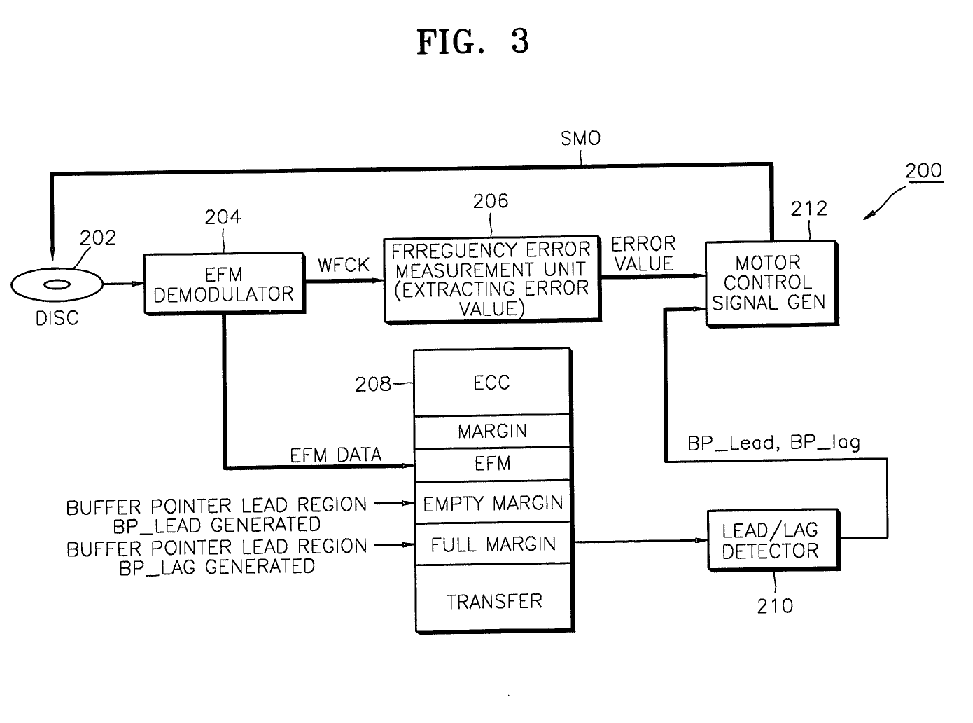

FIG. 3 is a block diagram illustrating the configuration of a spindle motor speed control apparatus according to the preferred embodiment of the present invention. The spindle motor speed control apparatus 200 includes an EFM demodulator 204, a frequency error measurement unit 206, a buffer 208, a lead/lag detector 210 and a motor control signal generator 212. The EFM demodulator 204 EFM-demodulates the data read from a disc and outputs EFM data and a WFCK (Write Frame Sync Clock). The frequency error measurement unit 206 compares the WFCK extracted from the EFM demodulator 204 with a theoretical WFCK, and outputs the difference between the WFCKs as an error value. The buffer 208 stores the EFM data.

The lead/lag detector 210 compares points in the buffer where the EFM data is recorded and transfer data is read to one another, and identifies whether the transfer pointer leads or lags behind an EFM pointer. The motor control signal generator 212 accelerates or decelerates the rotation speed of the spindle motor (not shown) that rotates the disc 202 based on the error value provided by the frequency error measurement unit 206 and the lead/lag information detected by the lead/lag detector 208, which compares the EFM pointer indicating the EFM data record location with the transfer pointer indicating the transfer data transmission location, and detects information about the lead/lag and the location difference between the two points.

According to the preferred embodiment of the present invention, the spindle motor speed control apparatus 200 detects whether the EFM pointer leads ahead of, or lags behind, the transfer pointer, and accelerates/decelerates the speed at which the data is read from the disc 202 by controlling the speed of the spindle motor.

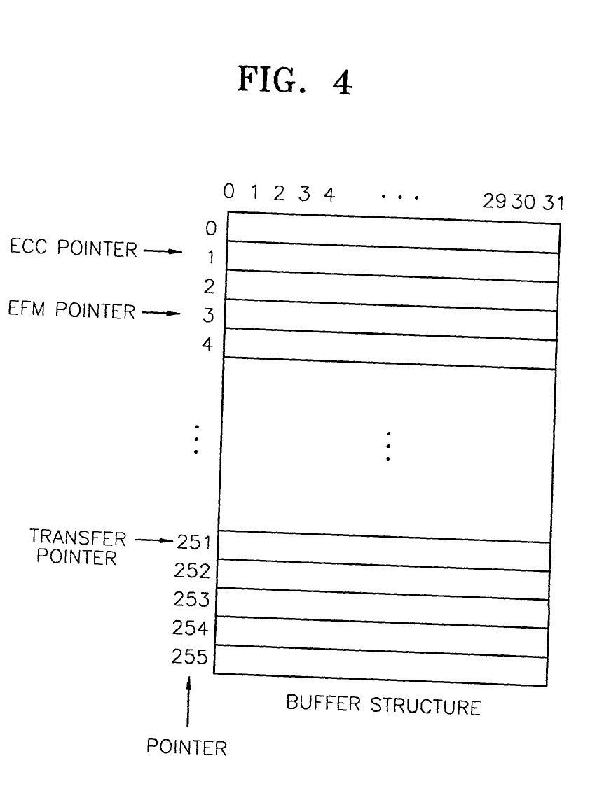

FIGS. 4 through 6 illustrate the operation of the apparatus 200 illustrated in FIG. 3 in greater detail. FIG. 4 shows the relations among an EFM (Eight-to-Fifteen Modulation) pointer, an ECC (Error Code Correction) pointer and a transfer pointer in the buffer 208 illustrated in FIG. 3.

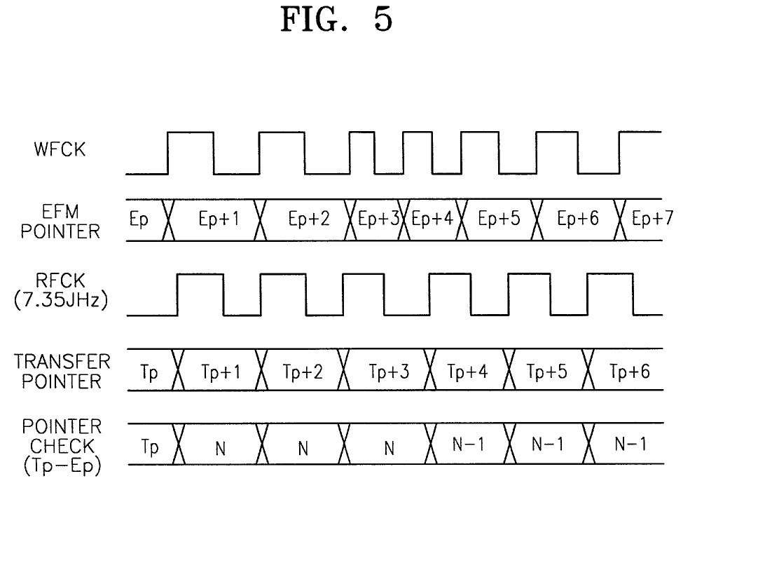

FIG. 5 is a waveform diagram illustrating the operation of the lead/lag detector 210 illustrated in FIG. 3. The first waveform shows the WFCK reproduced from the disc 202. The second diagram shows the value of the EFM pointer (Ep). The third diagram shows the clock signal (RFCK) with the fixed frequency used to read the transfer data. The fourth diagram shows the value of the transfer pointer (Tp) and the fifth diagram shows the difference (Tp−Ep) between the EFM pointer value and the transfer pointer value.

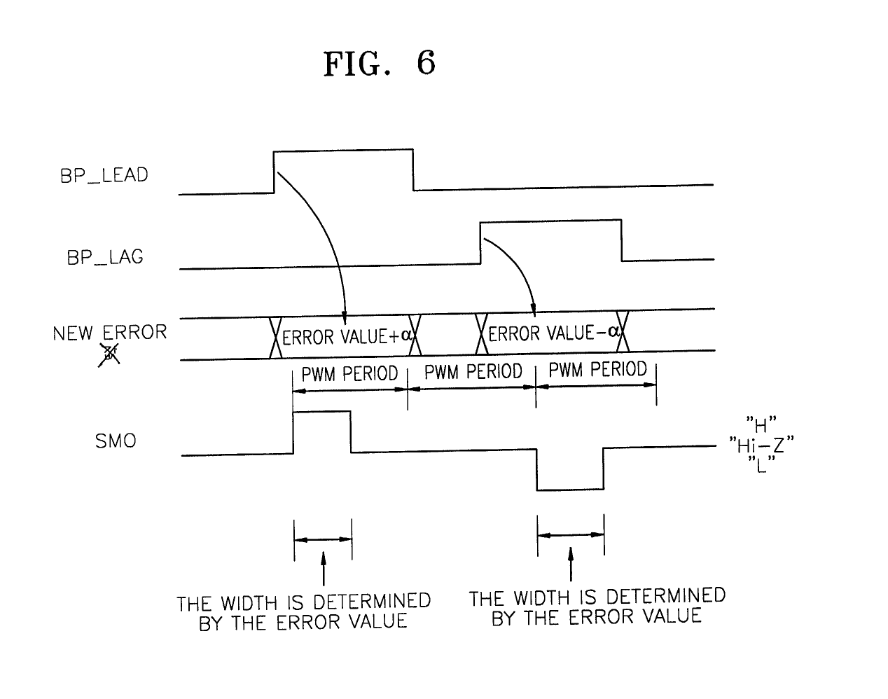

FIG. 6 is a waveform diagram illustrating the operation of the motor control signal generator 212 illustrated in FIG. 3. The first waveform shows the BP_LEAD signal generated in the lead/lag detector 210, and the second waveform shows the BP_LAG signal generated in the lead/lag detector 210. The BP_LEAD signal indicates that the transfer pointer is located before the EFM pointer in the buffer 208, while the BP_LAG signal indicates the transfer pointer is located after the EFM pointer in the buffer 208. In addition, both of the BP_LEAD signal and the BP_LAG signal indicate that the gap between the transfer pointer and the EFM pointer exceeds a prescribed range.

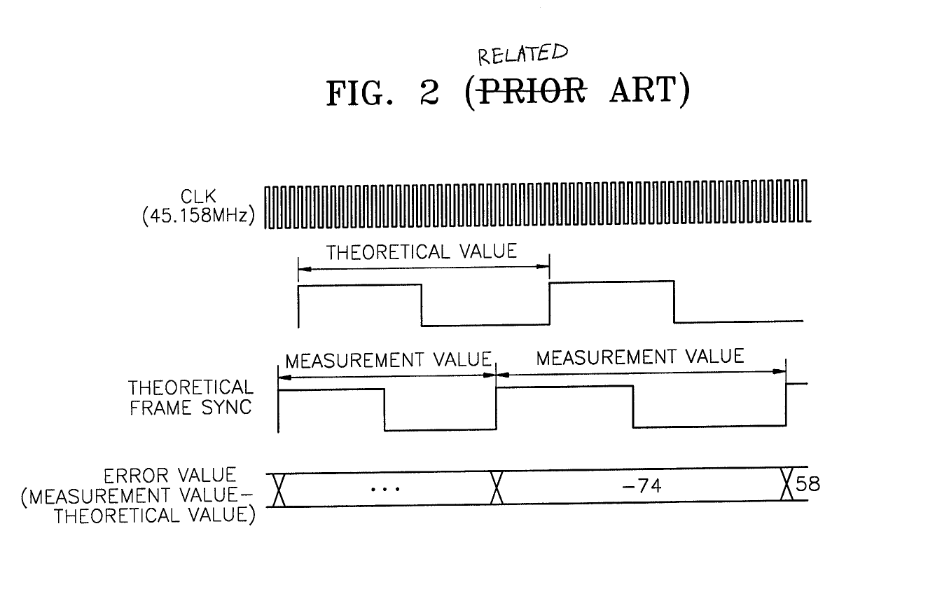

The third diagram shows a new error value obtained after the difference between the measured WFCK and the theoretical WFCK illustrated as the fourth waveform of FIG. 2, and the difference between the transfer pointer and the EFM pointer as described above is incorporated into the new error value.

The fourth diagram shows the spindle motor speed control signal SMO, which is generated depending on the error value of the third diagram of FIG. 6. A pulse width control signal is used as the spindle motor speed control signal. The pulse width is determined by application of the new error value shown in the third waveform to the BP_LEAD signal generation section shown in the first diagram, or to the BP_LAG signal generation section shown in the second diagram.

An exemplary embodiment of the present invention is described below. The theoretical WFCK is 7.35 KHz, the channel bit of the CD data recorded in the disc is 4.3218 MHz and one frame is made up of 588 bits in the case of 1× (i.e., normal reproduction speed). If the 45.1584 MHz clock signal generated by the crystal oscillator is counted, the frequency of the WFCK reproduced from the disc 202 can be measured. In the case of 1×, the coefficient value of the theoretical WFCK is 6144 =((1/7.25)/(1/45.1584)). The frequency error measurement unit 206 calculates the difference between the theoretical value and the measured value, and obtains the control value necessary to accelerate or decelerate the speed based on the difference value (i.e., error value).

The EFM data demodulated by the EFM demodulator 204 is saved in the buffer 208. Since one frame of the CD data includes 32 symbols (1 symbol=1 byte), the buffer is constructed by 256 rows of 32 bytes for easy control. That is, the EFM data reproduced by the disc is loaded into the buffer that includes 256 frames. The EFM pointer (Ep) manages the location where the EFM data is recorded. The EFM data saved in the buffer goes through the ECC. The ECC is classified into C1 and C2.

Typically, because ECC is performed immediately after the EFM data is recorded in the buffer 208, the gap between the EFM pointer (Ep) and the ECC is either 1 or 2. The ECC pointer is used to manage the location where the ECC is performed.

The transfer pointer (Tp) manages the transfer data to be transmitted for reproduction of the audio signal. The transfer rate of one frame is determined per RFCK (Read Frame Sync Clock) generated based on the clock signal with the fixed frequency. The EFM data and the transfer data are not processed at the same speed because the EFM data reproduction speed depends on the rotation speed of the variably controlled spindle motor, and the transfer data is transmitted at a fixed speed to prevent distortion of the audio signal.

Therefore, if the rotation speed of the disc 202 is faster than the processing speed of the transfer data, the gap between the EFM pointer (Ep) and the transfer pointer (Tp) becomes narrow, as shown in FIG. 4. The spindle motor is controlled to maintain a substantially constant gap between the EFM pointer and the transfer pointer.

Physical factors can create difficulties for accurate control of the spindle motor, such that the gap between the EFM pointer and the transfer pointer approaches zero. Then, the transfer data is broken, as the EFM data is recorded at a location where the transfer data is transmitted, prior to the transmission of the transfer data. As a result, the continuity of the audio data is broken. If the disc speed becomes slow, the gap between the transfer pointer (Tp) and the EFM pointer (Ep) increases and the transfer pointer (Tp) approaches the ECC pointer, such that new EFM data is recorded where EFM data has not gone through ECC. Therefore, it is very important to maintain a prescribed gap between the EFM pointer and the transfer pointer (Tp).

To address the above described physical factors and prevent the related art collision problems, the apparatus 200 of the present invention measures the frequency of the WFCK and controls the speed of the spindle motor. The apparatus 200 illustrated in FIG. 3 sets a prescribed value as a gap between the EFM pointer and the transfer pointer (Tp). If the gap falls below the certain value, the apparatus accelerates or decelerates the spindle motor by adjusting the existing error value (measurement value=theoretical value) gained after the WFCK frequency measurement within the pulse section created by the buffer pointer control.

If a current error value “+” indicates that the theoretical value is higher than the measurement value and the disc reproduction speed is slow, the apparatus accelerates the speed of the spindle motor. In addition, if the disc reproduction speed becomes slow and the BP_LEAD signal is generated, the apparatus adds (+α) to the error value and accelerates the speed of the spindle motor.

Correspondingly, if the current error value “−” indicates that the theoretical value is less than the measurement value and the disc reproduction speed is fast, the apparatus decelerates the speed of the spindle motor. If the disc reproduction speed becomes slow and the BP_LAG signal is generated, the apparatus adds (−α) to the error value and decelerates the speed of the spindle motor.

The present invention has various advantages. For example, but not by way of limitation, as described above, the spindle motor speed control apparatus according to the present invention detects lead or lag between the EFM pointer and the transfer pointer and the difference between the two points on the buffer, and can more easily and reliably control the speed at which the data stored on the disc is read, by controlling the spindle motor speed.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

What is claimed is:

1. A means for controlling spindle motor speed of an optical disc reproducing device having a buffer that buffers data reproduced from a disc and reproduces an audio signal, comprising:
an EFM demodulation means for EFM (Eight to Fifteen Modulation)demodulating the data read by the disc and outputting EFM data and a WFCK (Write Frame Sync Clock);
a frequency error measurement means for comparing a frequency of the WFCK extracted by the EFM demodulation means with a frequency of a theoretical WFCK and outputting the difference between the extracted WFCK and the theoretical WFCK as an error value;
a buffering means for storing the EFM data, performing ECC (Error Code Correction) of the stored EFM data and storing transfer data to be transmitted to an external system for reproduction of an audio signal after the ECC;
a lead/lag detection means for comparing points in the buffering means where the EFM data is recorded and the transfer data is read, and identifying transfer pointer leads or lags behind an EFM pointer; and
a motor control signal generating means for controlling the rotation speed of the spindle motor that rotates the disc, based on the error value provided by the frequency error measurement means and lead/lag information detected by the lead/lag detection means.

2. The means for controlling spindle motor speed of claim 1, wherein the lead/lag detection means compares the points in the buffering means where the EFM data is recorded and the transfer data is read, and generates the lead signal indicating the transfer pointer is located before the EFM pointer and the lag signal indicating the transfer pointer is located after the EFM pointer.

3. The means for controlling spindle motor speed of claim 2, wherein the lead/lag detection means generates the lead signal and the lag signal only when the gap between the transfer pointer and the EFM pointer exceeds a prescribed range.

4. The means for controlling spindle motor speed of claim 3, wherein the lead/lag detection means is configured to vary the prescribed range.

5. The means for controlling spindle motor speed of claim 1, wherein the motor control signal generation means adds −α or +α to the error value generated by the frequency error measurement means depending on the lead/lag information detected by the lead/lag detection means.

6. A spindle motor speed control apparatus, comprising:
an EFM (Eight to Fifteen Modulation) demodulator that demodulates data reproduced from a disc and outputs EFM data and a WFCK (Write Frame Sync Clock);
a frequency error measurement unit that compares a frequency of the WFCK extracted by the EFM demodulator with a frequency of a theoretical WFCK and outputs the difference between the extracted WFCK and the theoretical WFCK as an error value;
a buffer that stores the EFM data, performs ECC (Error Code Correction) of the stored EFM data and stores transfer data to be transmitted to an external system for reproduction of an audio signal after the ECC;
a lead/lag detector that compares points in the buffer where the EFM data is recorded and the transfer data is read, and identifies transfer pointer leads or lags behind an EFM pointer; and
a motor control signal generator that controls the rotation speed of the spindle motor that rotates the disc, based on the error value provided by the frequency error measurement unit and lead/lag information detected by the lead/lag detector, to reproduce an audio signal.

7. The spindle motor speed control apparatus of claim 6, wherein said spin motor speed control apparatus is coupled to an optical disc reproducing device.

8. The spindle motor speed control apparatus of claim 6, wherein the lead/lag detector generates at least one of a lead signal indicating a transfer pointer is located before the EFM pointer and a lag signal indicating the transfer pointer is located after the EFM pointer.

9. The spindle motor speed control apparatus of claim 8, wherein the lead/lag detector generates the at least one of the lead signal and the lag signal only when the gap between the transfer pointer and the EFM pointer exceeds a prescribed range.

10. The spindle motor speed control apparatus of claim 9, wherein the lead/lag detector is configured to vary the prescribed range.

11. The spindle motor speed control apparatus of claim 6, wherein the motor control signal generator adds −α or +α to the error value generated by the frequency error measurement unit depending on the lead/lag information detected by the lead/lag detector.

12. A method of controlling a spindle motor speed, comprising:
(a) demodulating data reproduced from a disc to generate EFM (Eight to Fifteen Modulation) demodulated data and extract a WFCK (Write Frame Sync Clock);
(b) comparing a frequency of the extracted WFCK with a frequency of a theoretical WFCK to output an error value comprising a difference between the extracted WFCK and the theoretical WFCK;
(c) buffering the EFM data, performing ECC (Error Code Correction) of the stored EFM data, and storing transfer data to be transmitted to an external system for reproduction of an audio signal after the ECC;
(d) comparing points where the EFM data is recorded and the transfer data is read to identify transfer pointer leads or lags behind an EFM pointer; and
(e) controlling the spindle motor rotation speed based on the error value and the lead/lag information, to reproduce an audio signal.

13. The method of claim 12, wherein said spindle motor control apparatus is applied to an optical disc reproducing device.

14. The method of claim 12, wherein said (d) generates at least one of a lead signal indicating a transfer pointer is located before the EFM pointer and a lag signal indicating the transfer pointer is located after the EFM pointer.

15. The method of claim 14, wherein said (d) generates the at least one of the lead signal and the lag signal only when the gap between the transfer pointer and the EFM pointer exceeds a prescribed range.

16. The method of claim 15, wherein the prescribed range can be varied.

17. The method of claim 12, wherein said (e) adds −α or +α to the error value depending on said pointer leads or lags detected in said (d).
